(19) United States
(12) Patent Application Publication
(10) Pub. No.: US 2010/0047401 A1
(43) Pub. Date: Feb. 25, 2010

(54) METHOD AND COMPOSITION FOR EXTRUDED PET FOOD PRODUCT

(75) Inventors: Donald R. Speck, Festus, MO (US); Stephen R. Dahl, Manchester, MO (US)

Correspondence Address: K&L Gates LLP, P.O. Box 1135, CHICAGO, IL, 60690, US

(73) Assignee: Nestec Ltd., Vevey (CH)

(21) Appl. No.: 12/610,880

(22) Filed: Nov. 2, 2009

Related U.S. Application Data
(63) Continuation of application No. 09/795,369, filed on Feb. 28, 2001.

(51) Int. Cl. A23K 1/18

(52) U.S. Cl. 426/94; 426/93

(57) ABSTRACT

A method for forming a pet food product includes supplying a basal formula to a feed section of an extruding system, passing the basal formula through the extruding system, supplying a particulate dough to the basal formula downstream of a compression section of the extruding system, mixing the basal formula and the particulate dough to form a pet food product, and forming the pet food product into discreet pieces. The formed pet food product includes an extruded basal portion and a granular portion mixed throughout the extruded basal portion.

### BACKGROUND OF THE INVENTION

This invention relates generally to pet food and more particularly, to extruded pet food that includes particulates.

### BRIEF SUMMARY OF THE INVENTION

In an exemplary embodiment of the invention, a pet food product includes a particulate dough mixed throughout an extruded basal portion. A method for forming the pet food product includes supplying a basal mixture to a feed section of an extruding system. The basal mixture is passed through the extruding system and the particulate dough is supplied to the basal mixture downstream of a compression section of the extruding system. The basal mixture and the particulate dough are mixed to form a pet food product which is formed into discreet pet food product pieces.

### BRIEF DESCRIPTION OF THE DRAWINGS

FIG. 1 is a schematic diagram of an extruding system utilized to make the pet food product.

FIG. 2 is a schematic diagram of an alternative extruding system utilized to make the pet food product

FIG. 3 is flow chart of a method for making an extruded pet food including particulates.

### DETAILED DESCRIPTION OF THE INVENTION

In one embodiment of the invention, a substantially grain based pet food product includes a grain based extruded basal portion and a particulate dough, i.e., a granular portion, including particulates. In one embodiment, the particulate dough includes about 5 to about 60 percent by weight of the pet food product. In an alternative embodiment, the particulate dough includes about 20 to about 50 percent by weight of the pet food product. In a further alternative embodiment, the particulate dough includes about 25 percent by weight to about 40 percent by weight of the pet food product. In a still further alternative embodiment, the particulate dough includes about 25 percent by weight to about 30 percent by weight of the pet food product. In yet another alternative embodiment, the particulate dough includes about 25 percent by weight of the pet food product.

In the exemplary embodiment, the particulates include at least one of cereal grains (such as corn, wheat, and rice), beans (such as soy beans), fiber (such as bran, cellulose, soy hulls, husks, shells, beet pulp, and corn cob), coarse bone meal, rawhide, textured vegetable protein, dried meat tissue, meat and poultry meals, and coarse mineral sources (such as coarse dicalcium phosphate). In one embodiment, the grains and beans are whole. In an alternative embodiment, the grains and beans are coarsely ground. In an exemplary embodiment, the particulates include whole and/or substantially whole rice and beet pulp. More particularly, in the exemplary embodiment, the basal mixture includes a mixture of soybean flour, corn, wheat, sugar, wheat gluten, corn gluten, dried molasses, wheat flour, soybean meal, calcium propionate, salt, glyceryl monostearate, and sorbic acid. In addition, the basal mixture includes flavorings, beef lung, beef gullet, stabilizers and vitamins. The particulate dough includes emulsified beef lungs and gullets, flavorings, stabilizers and vitamins as well as soybean flour, ground wheat, sugar, corn gluten, clear wheat flour, soybean meal, calcium propionate, salt and sorbic acid. In addition, the particulate dough includes beet pulp, whole rice, and colorings. In one embodiment, the beet pulp and the whole rice each comprise less than about ten percent by weight of the pet food product. In a further embodiment, the beet pulp and the whole rice each comprise less than about five percent by weight of the entire pet food product. In a still further embodiment, the beet pulp and the whole rice each comprise about two and a half percent by weight of the entire pet food product.

FIG. 1 is a schematic diagram of an extruding system 100 utilized to make the pet food product. Extruding system 100 includes an extruder 102, e.g., a single screw extruder, including a feed chute 104 located at an inlet 106. Single screw extruding systems are well known in the art. A basal mixture 108 is introduced to extruder inlet 106 through feed chute 104. Extruder 102 also includes a feed section 110 that collects and advances basal mixture 108 to a compression section 112 which cooks basal mixture 108 as described below. Basal mixture 108 then passes to a metering section 114 of extruder 102.

In one embodiment, metering section 114 includes an injection port 116 adjacent a discharge end 118 of extruder 102. A particulate dough (not shown) is injected through injection port 116 into extruder 102. The particulate dough is mixed with basal mixture 108 and is discharged through discharge end 118.

In an alternative embodiment, extruder 102 is a Wenger TX-52 twin screw extruder commercially available from Wenger Manufacturing, Inc., located in Sabetha Kans. The twin screw extruder includes a vent (not shown) located downstream of compression section 112 and at the entrance to metering section 114. The vent is separate from injection port 116 and is utilized to vent steam and pressure from basal mixture 108.

In a further alternative embodiment, extruder 102 is a Wenger TX-52 twin screw extruder commercially available from Wenger Manufacturing, Inc., located in Sabetha, Kans. and includes a vent (not shown) but not an injection port. Instead, particulates are dropped into extruder 102 through the vent and are mixed with the basal mixture in metering section 114. The vent also allows steam and pressure to escape from the basal mixture. In this embodiment, the vent is located at a position other than at discharge end 118 of extruder 102.

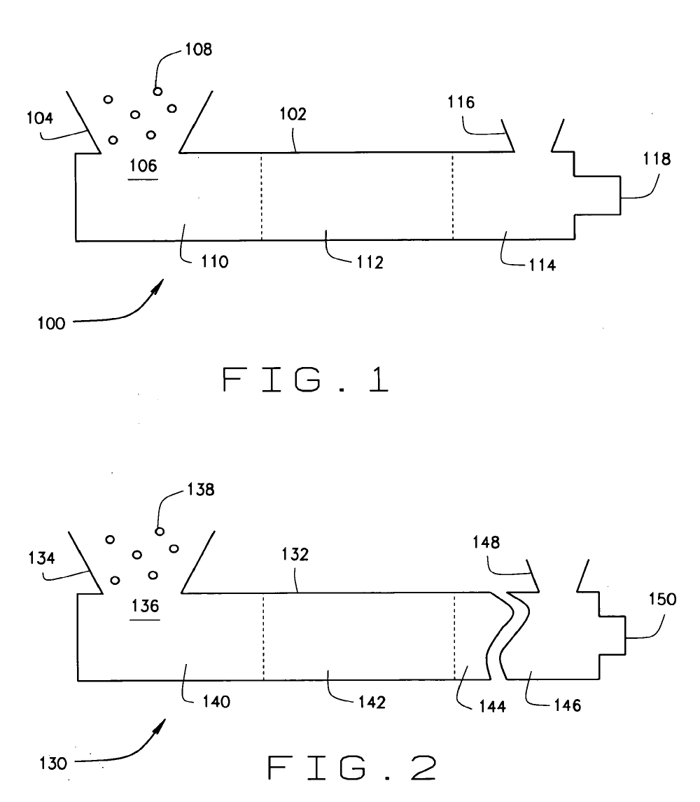

FIG. 2 is a schematic diagram of an alternative extruding system 130 utilized to make the pet food product. Extruding system 130 includes an extruder 132, e.g., a single screw extruder, including a feed chute 134 located at an inlet 136. Single screw extruders are well known in the art. A basal mixture 138 is introduced to extruder inlet 136 through feed chute 134. Extruder 132 also includes a feed section 140 that collects and advances basal mixture 138 to a compression section 142 which cooks basal mixture 138 as described below. Basal mixture 138 then passes to a metering section 144 of extruder 132 and on to a former section 146. In one embodiment, former section 146 is integral with metering section 144. In an alternative embodiment, former section 146 is separated from metering section 144 and basal mixture 138 passes from a metering section outlet (not shown) to a former section inlet (not shown). Former section 146 includes an injection port 148 adjacent a former section discharge end 150. A particulate dough (not shown) is injected through injection port 148 into former section 146. The particulate dough is mixed with basal mixture 138 and is discharged through discharge end 150.

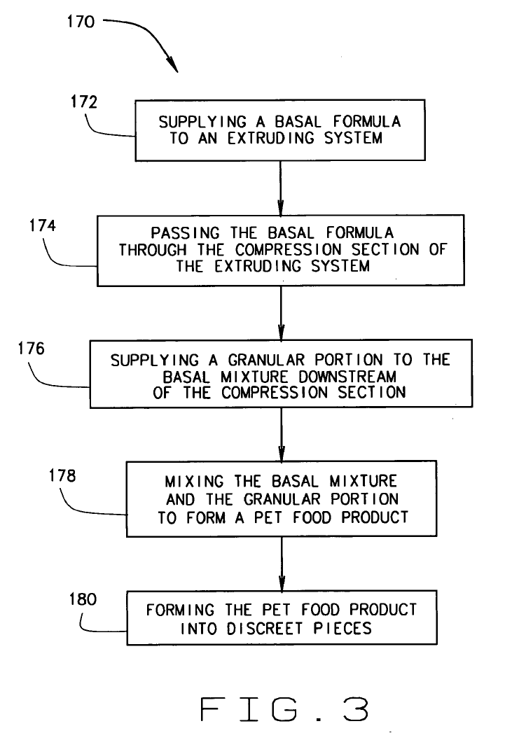

FIG. 3 is a flow chart illustrating a method 170 of making an extruded pet food product including particulates. Method 170 includes supplying 172 a basal mixture to a feed section of an extruding system. In addition, method 170 includes passing 174 the basal mixture through the extruding system from the feed section to a compression section. The compression section cooks the basal mixture and shears and melts individual grain particles within the mixture. The grain particles are melted by action of a screw within the extruder breaking down the particles into smaller pieces and increasing the temperature until the particles begin to melt. In one embodiment, the basal mixture temperature is about 240 degrees Fahrenheit to about 280 degrees Fahrenheit and the mixture pressure is about 500 pounds per square inch gage (psig) to about 1200 psig. The mixture is thus subjected to high temperatures and shear imparted by the extruder in the compression section. The basal mixture is then passed to a metering section of the extruder. In an alternative embodiment, the basal mixture is further passed to a former section.

Method 170 also includes supplying 176 a granular portion, e.g., a granular mixture, a particulate dough, particulates, to the basal mixture downstream of the compression section of the extruding system and mixing 178 the basal mixture and the particulate dough to form a pet food product. In one embodiment, the granular mixture substantially includes particulates.

In one embodiment, supplying 176 a granular portion, e.g., a granular mixture, a particulate dough, particulates, includes injecting a particulate dough into a discharge end of the metering section of a non-vented extruder that does not include a former section. The location at which the particulate dough is injected into the metering section is such that the extruder adequately mixes the dough into the basal mixture without substantially breaking down, i.e., grinding, the particles. In an exemplary embodiment, an injection port is located one and a half screw flights from the discharge end of the extruder.

In an alternative embodiment, supplying 176 a granular portion, e.g., a granular mixture, a particulate dough, particulates, includes supplying a stream of particles, i.e., a granular mixture, to a vented twin screw extruder that cooks the mixture in the first one third to one half of the extruder, vents steam near the middle of the extruder, and accepts particulate dough in the final one third of the extruder. The particles are dropped in a vent of the extruder which then mixes the particles with the basal mixture. The particles are not included in a paste, but instead comprise a mixture of particles. The location at which the particles are dropped into the extruder is such that minimal breaking down of the particles occurs.

In a further alternative embodiment, supplying 176 a granular portion includes injecting a particulate dough into a vented twin screw extruder that cooks the mixture in the first one third to one half of the extruder, vents steam near the middle of the extruder, and accepts particulate dough in the final one third of the extruder. The location at which the particulate dough is injected into the metering section is such that the extruder adequately mixes the dough into the basal mixture without substantially breaking down, i.e., grinding, the particles. In an exemplary embodiment, an injection port is located near the discharge end of the extruder.

In a still further alternative embodiment, supplying 176 a granular portion includes injecting the particulate dough into the former section at a discharge end of the former section. The location at which the particulate dough is injected into the former section is such that the extruder adequately mixes the dough into the basal mixture without substantially breaking down, i.e., grinding, the particles. For example, an injection port is located one and a half screw flights from the discharge end of the former section. In one embodiment, the former section is integral with the extruder. In an alternative embodiment, the former section is remote from the extruder.

Method 170 also includes forming 180 the pet food product into discreet pieces that have the appearance of dried meat. In the exemplary embodiment, the finished pieces include a smooth dense matrix with a meat appearance and texture provided by the particles and the fiber and the finished pieces are imitation stick or jerky. In an alternative embodiment, the discreet pieces have the appearance of a grain bar. In a further alternative embodiment, the discreet pieces are dog treats. In a still further alternative embodiment, the discreet pieces are one of cat treats, dog food, cat food, other pet food, and other pet treats.

The appearance of the finished pieces can be altered depending on whether the mixture is allowed to vent prior to exit from the extruding system. For example, if the extruding system does not include a forming section and the extruder does not vent to atmosphere, the resulting product will be an expanded product. If however, the extruder vents to atmosphere and then the vented product is transferred to a post extruder former, the product will be a dense product.

While the invention has been described in terms of various specific embodiments, those skilled in the art will recognize that the invention can be practiced with modification within the spirit and scope of the claims.

1-43. (canceled)

44. An extruded pet food product formed by an extruding system including an extruder having a feed section and a compression section, said pet food product comprising at least one of a dog food product and a cat food product, said pet food product comprising:
an extruded basal portion that has been subjected to high temperatures and shear imparted by the extruder in the compression section; and
a granular portion including substantially whole grains that was supplied to said basal portion in the extruder downstream of the extruder compression section, the granular portion being mixed with the extruded basal portion, wherein the granular portion is not subjected to high temperatures and shear imparted by the compression section.

45. A pet food product in accordance with claim 44, wherein said granular portion is mixed throughout said basal portion.

46. A pet food product in accordance with claim 44, wherein said pet food product has the appearance of meat.

47. A pet food product in accordance with claim 44, wherein said pet food product has the appearance of a grain bar.

48. A pet food product in accordance with claim 44, wherein the extruding system includes a vent and the pet food product is a dense product.

49. A pet food product in accordance with claim 44, wherein said granular portion comprises a particulate dough.

50. A pet food product in accordance with claim 49, wherein said particulate dough comprises about 5 to about 60 percent by weight of said pet food product.

51. A pet food product in accordance with claim 49, wherein said particulate dough comprises about 25 to about 40 percent by weight of said pet food product.

52. A pet food product in accordance with claim 49, wherein said particulate dough comprises about 25 percent by weight of said pet food product.

53. A pet food product in accordance with claim 44, wherein said granular portion comprises a granular mixture.

54. A pet food product in accordance with claim 53, wherein said granular mixture comprises less than about 20 percent by weight of said pet food product.

55. A pet food product in accordance with claim 53, wherein said granular mixture comprises less than about 10 percent by weight of said pet food product.

56. A pet food product in accordance with claim 53, wherein said granular mixture comprises about 5 percent by weight of said pet food product.

57. A pet food product in accordance with claim 44, wherein said basal portion comprises a grain based formula.

58. A pet food product in accordance with claim 44, wherein said pet food product comprises a substantially grain based product.

59. A pet food product in accordance with claim 44, wherein the basal portion is subjected to a temperature of about 240 degrees Fahrenheit to about 280 degrees Fahrenheit in the compression section.

60. A pet food product in accordance with claim 44, wherein the basal portion is subjected to a pressure of about 500 pounds per square inch gage (psig) to about 1200 psig.

61. A pet food product comprising at least one of a dog food product and a cat food product, said pet food product comprising:
an extruded basal portion that has been cooked in an extruder including a compression section; and
a granular portion mixed throughout said extruded basal portion and that was supplied to said basal portion in the extruder downstream of the extruder compression section, wherein the granular portion is not subjected to high temperatures and shear imparted by the compression section.

62. A pet food product in accordance with claim 61, wherein said granular portion comprises substantially whole beans.

63. A pet food product in accordance with claim 61, wherein said granular portion comprises at least one of a bone source, a rawhide, a vegetable protein, a dried meat tissue, a meat meal, a poultry meal, and a coarse mineral source.

64. A pet food product in accordance with claim 61, wherein said granular portion comprises a particulate dough.

65. A pet food product in accordance with claim 64, wherein said particulate dough comprises about 5 to about 60 percent by weight of said pet food product.

66. A pet food product in accordance with claim 64, wherein said particulate dough comprises about 25 to about 40 percent by weight of said pet food product.

67. A pet food product in accordance with claim 64, wherein said particulate dough comprises about 25 percent by weight of said pet food product.

68. A pet food product in accordance with claim 61, wherein said granular portion comprises a granular mixture.

69. A pet food product in accordance with claim 68, wherein said granular mixture comprises less than about 20 percent by weight of said pet food product.

70. A pet food product in accordance with claim 68, wherein said granular mixture comprises less than about 10 percent by weight of said pet food product.

71. A pet food product in accordance with claim 68, wherein said granular mixture comprises about 5 percent by weight of said pet food product.

72. A pet food product in accordance with claim 61, wherein the extruding system includes a vent and the pet food product is a dense product.

73. A pet food product in accordance with claim 61, wherein said pet food product comprises a substantially grain based product.

74. A pet food product in accordance with claim 61, wherein the basal portion is subjected to a temperature of about 240 degrees Fahrenheit to about 280 degrees Fahrenheit in the Compression section.

75. A pet food product in accordance with claim 61, wherein the basal portion is subjected to a pressure of about 500 pounds per square inch gage (psig) to about 1200 psig.
